(19) United States
(12) Patent Application Publication
(10) Pub. No.: US 2015/0000947 A1
(43) Pub. Date: Jan. 1, 2015

(54) Impact Mechanism Device

(71) Applicant: Robert Bosch GmbH, Stuttgart (DE)

(72) Inventors: Tobias Herr, Stuttgart (DE); Steffen Tiede, Herrenberg (DE); Benjamin Nikolas Fischle, Murr (DE); Hardy Schmid, Stuttgart (DE); Gerd Schlesak, Tamm (DE); Selim Mustafa, Stuttgart (DE)

(21) Appl. No.: 14/315,402

(22) Filed: Jun. 26, 2014

(30) Foreign Application Priority Data
Jun. 28, 2013 (DE) 10 2013 212 753.7

(51) Int. Cl. B25D 11/10; B25D 17/00

(52) U.S. Cl. CPC B25D 11/10; B25D 17/00
USPC 173/125

(57) ABSTRACT

An impact mechanism device for a hand power tool comprises at least one impact mechanism including at least one driven cylinder and at least one piston driven in an axial direction by the at least one driven cylinder via a cam mechanism, and at least one planetary gearing configured to drive the at least one driven cylinder and the at least one piston. The at least one piston is positioned at least partially inside the at least one driven cylinder.

This application claims priority under 35 U.S.C. §119 to patent application no. DE 10 2013 212 753.7, filed on Jun. 28, 2013 in Germany, the disclosure of which is incorporated herein by reference in its entirety.

### BACKGROUND

There has already been proposed an impact mechanism device for a hand power tool, comprising at least one impact mechanism, which has at least one driven cylinder and at least one piston that is driven in an axial direction by the cylinder, via a cam mechanism, and comprising at least one planetary gearing, via which the cylinder and the piston of the impact mechanism can be driven.

### SUMMARY

The disclosure is based on an impact mechanism device for a hand power tool, comprising at least one impact mechanism, which has at least one driven cylinder and at least one piston that is driven in an axial direction by the cylinder, via a cam mechanism, and comprising at least one planetary gearing, via which the cylinder and the piston of the impact mechanism can be driven.

It is proposed that the piston of the impact mechanism be disposed at least partially inside the driven cylinder. A “hand power tool” is to be understood to mean, in particular, a machine that performs work on workpieces, but advantageously a rotary hammer and/or percussion hammer and/or a multifunction tool. An “impact mechanism” in this case is to be understood to mean, in particular, a device provided to generate percussion impulses, which are transmitted to a tool clamped in a tool receiver in order to convert a chiseling or hammer drilling operating mode, the impact mechanism being provided to convert a rotary motion into a linear impact motion. The impact mechanism in this case preferably has a piston that, by means of an axial motion, generates a pressure impulse inside the hammer tube of the impact mechanism, the pressure impulse being taken up by an impact element and transmitted to the tool fastened in the tool receiver. A “driven cylinder” in this case is to be understood to mean an element that, at least substantially, has a hollow-cylinder cross section and that is driven rotationally about its central axis. A “cam mechanism” in this case is to be understood to mean, in particular, a device for converting a rotational motion into a linear motion. The linear motion in this case is preferably oriented in the axial direction. The cam mechanism in this case comprises a guide element, which is preferably realized as a groove, and a form closure element, which is in form-closed contact with the cam element for the purpose of guidance. An “axial direction” in this case is to be understood to mean, in particular, a direction that is parallel to a main direction of rotation of a tool clamped in a tool receiver. A “planetary gearing” in this context is to be understood to mean, in particular, a toothed wheel gearing having a sun gear, a planet carrier, at least one planet gear that is carried on a circular orbit around the sun gear by the planet carrier, and having a ring gear that meshes radially outwardly with the at least one planet gear. “At least partially inside” in this case is to be understood to mean, in particular, that at least a part of the piston is disposed inside the cylinder. It is thereby possible to achieve an impact mechanism device that is advantageously short in the axial direction, thus making it possible, in particular, to provide a particularly advantageously compact hand power tool.

Further, it is proposed that the piston be realized as a hollow piston, which is moved axially to generate a pressure impulse. A “hollow piston” in this case is to be understood to mean, in particular, a piston having a basic shape of a hollow cylinder, the piston being open on one axial side and closed on an opposite side. An axial motion of the piston causes a pressure impulse to be generated inside the piston, which pressure impulse encounters an element disposed inside the piston, such as, in particular, a striker of the impact mechanism, which takes up the pressure impulse and transmits it, directly or via further intermediate elements, to a tool in the tool receiver. As a result, particularly advantageously, the piston can be realized for a short impact mechanism structure.

It is additionally proposed that the piston have, on its outer circumference, an outer curve that realizes the piston-side cam mechanism. An “outer curve” in this case is to be understood to mean, in particular, a guide path disposed on an outer circumference of the piston, the guide path preferably being realized as a groove. As a result, the cam mechanism can be realized in a particularly advantageous manner.

Furthermore, it is proposed that the piston have, on its outer circumference, a further outer curve that, together with the one outer curve, realizes the piston-side cam mechanism. A “further outer curve” in this case is to be understood to mean, in particular, an outer curve realized so as to be identical in its course to the other outer curve of the piston-side cam mechanism, only disposed in an offset manner in the circumferential direction on the outer circumference of the piston. The outer curves in this case are preferably disposed in a non-uniformly distributed manner on the circumference. The outer curves in this case are distributed on the circumference at an angular distance of other than 180 degrees. As a result, forces can be apportioned advantageously to the outer curves and to the form closure elements engaging in the outer curves, and consequently reduced for each individual element, enabling a service life of the impact mechanism device to be increased in a particularly advantageous manner.

It is further proposed that the outer curve and the further outer curve be distributed in a non-uniform manner on the outer circumference of the piston. “Distributed in a non-uniform manner on the circumference” is to be understood to mean, in particular, that the outer curves at an axial position in a first circumferential direction are at a different distance from each other than in an opposite, second circumferential direction. The outer curves in this case have, in particular, an angular distance from each other that is other than 180 degrees. As a result, particularly advantageously, it is possible to prevent a collision of form closure elements engaging in the different outer curves.

Moreover, it is proposed that the piston be composed of a first, lighter material, and the outer curve be composed of a second, harder material. A “first, lighter material” in this case is to be understood to mean, in particular, a light metal, a plastic, or another light material considered appropriate by persons skilled in the art. A “harder material” in this case is to be understood to mean, in particular, a material that is harder and more wear resistant than the first material. In this case, the “second, harder material” is to be understood to mean, in particular, a material that has been hardened, or that has been coated to increase wear resistance, and that, in particular, has a greater hardness. As a result, the piston can be made particularly light and, at the same time, particularly advantageously, the curved path can be particularly wear resistant, thus making it possible, in particular, to achieve advantageous quietness of running and a particularly advantageous wear behavior of the impact mechanism device.

It is furthermore proposed that the cylinder have at least one form closure element, which engages in the outer curve for the purpose of guiding the piston. As a result, the cam mechanism can be realized in a particularly advantageous manner.

Further, it is proposed that the cylinder be driven via a first output of the at least one planetary gearing, and the piston be driven via a second output of the at least one planetary gearing. An “output of a planetary gearing” in this case is to be understood to mean, in particular, an element of the planetary gearing such as, in particular, a sun gear, a ring gear or a planet carrier, via which a moment is diverted out of the planetary gearing. As a result, the impact mechanism device can be realized in a particularly advantageous manner, and a differential rotational speed can be achieved between the piston and the cylinder.

Moreover, it is proposed that the first output, via which the cylinder is driven, be realized as a sun gear of the second planetary gearing. As a result, the impact mechanism device can be realized in a particularly advantageously compact manner.

Furthermore, it is proposed that the impact mechanism device comprise at least one switching device, which is provided for mechanical switching of various operating modes. “Mechanical switching” in this case is to be understood to mean, in particular, switching that is preferably effected purely mechanically, i.e. in which a force and/or a movement initiated by an operator is taken up by a mechanism and a switching operation is converted by a movement of the mechanism, the mechanical switching, in particular, not making use of an electronic component. In this way, particularly advantageously, various operating modes can be switched by an operator.

In addition, it is proposed that the switching device comprise at least one slide sleeve, which has form closure elements for coupling to a tool receiver and for actuating a coupling point of the switching device for the purpose of coupling the piston. A “slide sleeve” in this case is to be understood to mean, in particular, a sleeve that is mounted so as to be axially displaceable and that, because of its design, switches differing operating states in differing positions. As a result, the various operating states can be switched particularly easily.

Further, it is proposed that the coupling point of the switching device comprise radially displaceable form closure elements, which are optionally held in a form closure or released by the slide sleeve, for the purpose of coupling and decoupling the piston. “Decoupling the piston” in this case is to be understood to mean, in particular, undoing a rotationally fixed connection between the piston and a drive, such that the piston is no longer driven rotationally. “Coupling the piston” in this case is to be understood to mean, in particular, establishing a rotationally fixed connection between the piston and a drive, such that the piston is driven rotationally. As a result, a percussive operating mode of the impact mechanism can be switched particularly easily and rapidly.

It is further proposed that the impact mechanism device have a mechanical switchover unit, which, for the purpose of switching over a direction of rotation of a tool receiver, is provided to fix optionally a ring gear or a planet carrier of the second planetary gearing. The term “to fix” in this case is to be understood to mean, in particular, to connect to a housing element in a rotationally fixed manner. As a result, a direction of rotation of a tool that is clamped in the tool receiver can be switched over by an operator in an advantageously simple and rapid manner.

The impact mechanism device according to the disclosure is not intended in this case to be limited to the application and embodiment described above. In particular, the impact mechanism device according to the disclosure may have individual elements, components and units that differ in number from a number stated herein, in order to fulfill a principle of function described herein.

Further advantages are given by the following description of the drawings. The drawings show five exemplary embodiments of the disclosure. The drawing, the description and the claims contain numerous features in combination. Persons skilled in the art will also expediently consider the features individually and combine them to create appropriate further combinations.

### BRIEF DESCRIPTION OF THE DRAWINGS

In the drawings:

FIG. 1 shows a hand power tool comprising an impact mechanism device according to the disclosure, in a first exemplary embodiment,

FIG. 2 shows a cylinder and a piston of an impact mechanism device according to the disclosure, in a first exemplary embodiment,

FIG. 3 shows a schematic representation of an impact mechanism device, in a second exemplary embodiment,

FIG. 4 shows a portion of a switching device of the impact mechanism device, in the second exemplary embodiment,

FIG. 5 shows a schematic representation of an impact mechanism device, in a third exemplary embodiment, and

FIG. 6 shows a schematic representation of an impact mechanism device, in a fourth exemplary embodiment.

### DETAILED DESCRIPTION

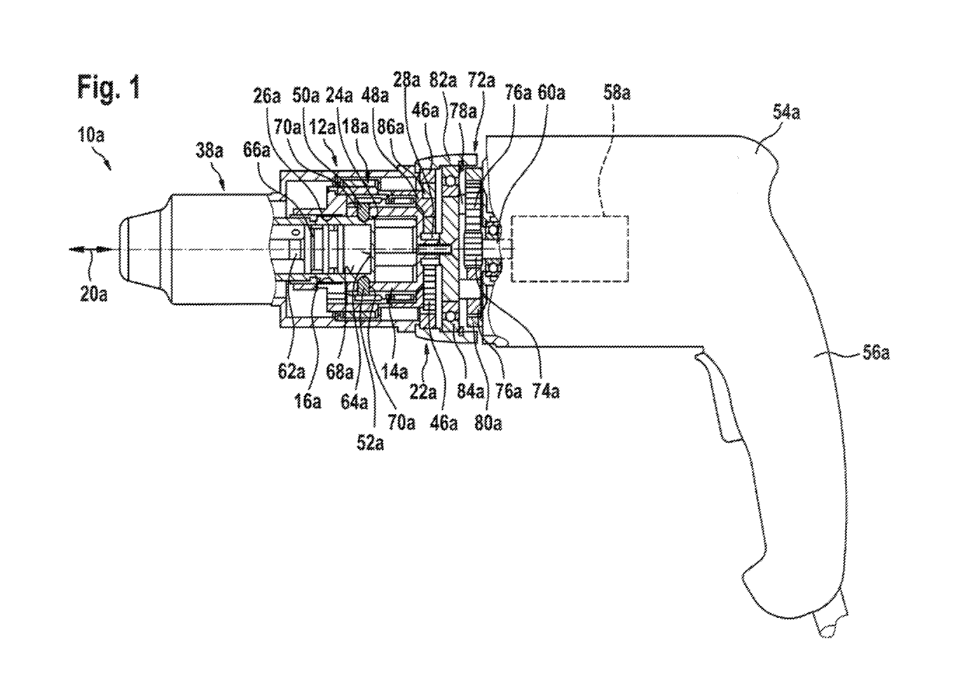

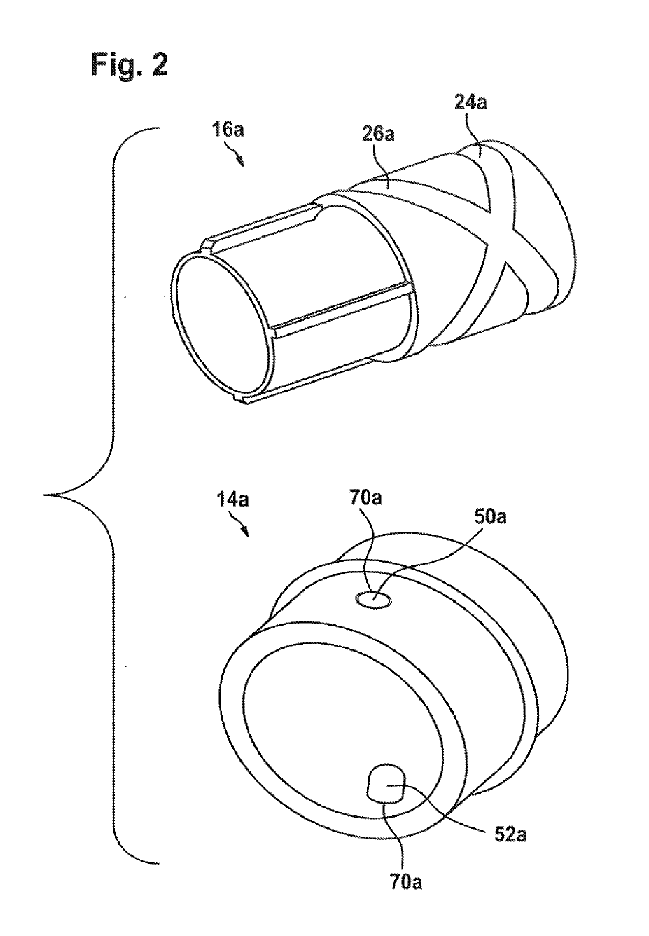

FIGS. 1 and 2 show a hand power tool 10a, comprising an impact mechanism device according to the disclosure, in a first exemplary embodiment. The hand power tool 10a is realized as a rotary hammer. The hand power tool 10a, realized as a rotary hammer, has a pistol-shaped machine housing 54a, in which the impact mechanism device according to the disclosure is disposed. A handle 56a, which comprises an operating element, is disposed on the machine housing 54a. The hand power tool 10a can be actuated via the operating element. It is also conceivable in principle for the hand power tool 10a to have a machine housing of a different design, considered appropriate by persons skilled in the art. For the purpose of driving the hand power tool 10a, the hand power tool 10a comprises a drive unit 58a. The drive unit 58a in this case is realized as an electric motor. It is also conceivable in principle for the drive unit 58a to be realized as a different drive unit 58a, considered appropriate by persons skilled in the art. In this case, the drive unit 58a is merely indicated in FIG. 1. The hand power tool 10a comprises a drive shaft 60a, which is driven rotationally by the drive unit 58a. The hand power tool 10a comprises a tool receiver 38a, which is disposed at a front end of the hand power tool 10a. The tool receiver 38a is provided to receive a tool. The tool in this case may be realized as a chisel or, for example, as a drill bit.

The impact mechanism device is provided to drive the tool receiver 38a, and in particular a tool clamped in the tool receiver 38a. The impact mechanism device comprises an impact mechanism 12a. The impact mechanism 12a in this case is provided to transmit an impulse to the tool mounted in the tool receiver 38a. For this purpose, the impact mechanism 12a comprises an impact element 62a, which is mounted so as to be axially displaceable in relation to the tool receiver 38a, and which is provided to transmit an impulse to the tool mounted in the tool receiver 38a. The impact element 62a in this case is provided to transmit a pneumatic pressure impulse, acting upon one side of the impact element 62a, to the tool. In order to generate the pneumatic pressure impulse, the impact mechanism 12a has a piston 16a. The piston 16a is provided to generate the pneumatic pressure impulse that acts upon the impact element 62a, by means of an axial motion. The piston 16a in this case is realized as a hollow piston. The piston 16a has a hollow-cylinder basic body. In this case, a central recess in the piston 16a is open on one axial side, and closed on an opposite axial side. The recess in the piston 16a, which realizes the piston 16a as a hollow piston, is realized as a blind hole. The piston 16a is open at a first end and closed by a wall 64a at a second end. In this case, in a mounted state, the first end, at which the recess is open, is aligned in the direction of the tool receiver 38a, i.e. in a front region of the hand power tool 10a. The impact element 62a in this case is disposed inside the piston 16a that is realized as a hollow piston. The impact element 62a in this case projects from the first end into the recess of the hollow piston. In this case, the impact element 62a is disposed so as to be axially movable inside the piston 16a. The impact element 62a in this case realizes a sealing element 66a at a first end, which faces away from the tool receiver 38a. The sealing element 66a bears against an inner wall 68a of the piston 16a realized as a hollow piston, and thereby seals off a pressure chamber between the wall 64a, which delimits the recess of the piston 16a, and the sealing element 66a. The piston 16a in this case is composed of a first, light material. The piston 16a in this case is composed of a light metal, in particular an aluminum. Clearly, it is also conceivable in principle for the piston 16a to be composed of another material, considered appropriate by persons skilled in the art, such as, for example, another metal such as, in particular, another light metal or plastic.

For the purpose of driving the piston 16a in the axial direction, i.e. for the purpose of generating the pressure impulse by means of the piston 16a, the impact mechanism 12a has a cylinder 14a. The cylinder 14a is realized as a hollow cylinder, which is closed on one side by a wall. The cylinder 14a is provided to move the piston 16a back and forth axially. The impact mechanism device comprises a cam mechanism 18a, for driving the piston 16a axially. The piston 16a in this case is driven in the axial direction by the cylinder 14a, via the cam mechanism 18a. For the purpose of realizing the cam mechanism 18a on the piston side, the piston 16a has a first outer curve 24a on its outer circumference. The first outer curve 24a is realized as a groove made in the outside of the piston 16a. In this case, the groove constituting the first outer curve 24a has a semicircular cross section. Owing to the semicircular cross section, unfavorable notch effects can be reduced, as compared with a rectangular cross section. For the purpose of realizing the cam mechanism 18a on the piston side, the piston 16a has a second outer curve 26a. The second outer curve 26a is likewise constituted by a groove. In this case, the groove is identical in form to the groove constituting the first outer curve 24a. The first outer curve 24a and the second outer curve 26a each have a course that is identical to the other. The first outer curve 24a and the second outer curve 26a are disposed in an offset manner on the outer circumference of the piston 16a. In this case, the outer curves 24a, 26a are distributed in a non-uniform manner on the outer circumference of the piston 24a. On the outer circumference of the piston 16a, the outer curves 24a, 26a have an angular distance from each other that is other than 180 degrees. The outer curves 24a, 26a realize a wave shape, aligned in the axial direction, on the outer circumference. The outer curves 24a, 26a in this case each realize a sine shape. However, it is also conceivable in principle for the outer curves 24a, 26a to have a wave shape other than a sine shape. The outer curves 24a, 26a in this case are composed of a second, harder material. In this case, the outer curves 24a, 26a are composed of a hardened material. It is conceivable in this case for the outer curves and the piston to be produced in a multicomponent process. Owing to the second, harder material, the outer curves 24a, 26a are realized so as to be more resistant to wear than a remainder of the piston 16a. It is also conceivable in principle in this case for the outer curves 24a, 26a to have a coating by which the outer curves 24a, 26a are made more resistant to wear. It is also conceivable in principle for the outer curves 24a, 26a to be made harder than the rest of the piston 16a in another way, considered appropriate by persons skilled in the art. The cam mechanism 18a comprises two form closure elements 50a, 52a, which are each provided for guidance in an outer curve 24a, 26a of the piston 16a. The form closure elements 50a, 52a are realized as pins. The form closure elements 50a, 52a in this case are fixedly connected to the cylinder 14a of the impact mechanism device. The form closure elements 50a, 52a are fixedly disposed at a position on the cylinder 14a. For the purpose of fastening the form closure elements 50a, 52a, the cylinder 14a has a radially extending through hole 70a in each case. The form closure elements 50a, 52a in this case are each respectively disposed in one of the through holes 70a, and thereby connected to the cylinder 14a in a stationary manner, but having play and being rotatable. The form closure elements 50a, 52a are each fixedly disposed in the through holes 70a by means of press fits. In a mounted state, the form closure elements 50a, 52a project inwardly into the cylinder 14a. In a mounted state, the form closure elements 50a, 52a are disposed in the outer curves 24a, 26a of the piston 16a by an inner region projecting inwardly into the cylinder 14a. As a result, the piston 16a is guided in a constrained manner in relation to the cylinder 14a by means of the form closure elements 50a, 52a and the outer curves 24a, 26a. Upon a relative rotation between the cylinder 14a and the piston 16a, the piston 16a is moved axially back and forth inside the cylinder 14a by the cam mechanism 18a.

For the purpose of transmitting a rotational speed and a torque from the drive unit 58a to the impact mechanism 12a, the impact mechanism device comprises a first planetary gearing 72a. The first planetary gearing 72a comprises a sun gear 74a, three planet gears 76a that mesh radially outwardly on the sun gear 74a, a planet carrier 78a, which carries the planet gears 76a in a rotatable manner in each case, and a ring gear 80a, which is disposed radially outside of the planet gears 76a, and which meshes with the planet gears 76a. The sun gear 74a is connected in a rotationally fixed manner to the drive shaft 60a, which is directly driven by the drive unit 58a. Via the sun gear 74a, a rotation is introduced into the first planetary gearing 72a. The ring gear 80a of the first planetary gearing 72a is connected in a rotationally fixed manner to a housing element 82a of the machine housing 54a, i.e. is stationary. It is also conceivable in principle for the ring gear 80a of the first planetary gearing 72a to be directly connected in a rotationally fixed manner to the machine housing 54a. The planet carrier 78a of the first planetary gearing 72a realizes an output of the first planetary gearing 72a, via which a rotation is diverted out of the first planetary gearing 72a. The impact mechanism device in this case comprises a rolling bearing 84a, by means of which the planet carrier 78a is realized so as to be rotatable in relation to the housing element 82a. The planet carrier 78a extends from a rolling plane, on which the planet gears 76a, the sun gear 74a and the ring gear 80a mesh with each other, in the direction of the tool receiver 38a and away from the drive unit 58a. The impact mechanism device comprises a second planetary gearing 22a. The second planetary gearing 22a is positioned after the first planetary gearing 72a, as viewed from the drive unit 58a. The second planetary gearing 22a, as also the first planetary gearing 72a, has a sun gear 28a, three planet gears 86a that mesh radially outwardly on the sun gear, a planet carrier 48a, which carries the planet gears 86a in a rotatable manner in each case, and a ring gear 46a, which is disposed radially outside of the planet gears 86a, and which meshes with the planet gears 86a. The sun gear 28a of the second planetary gearing 22a realizes an input of the second planetary gearing 22a. The sun gear 28a of the second planetary gearing 22a is connected in a rotationally fixed manner to the planet carrier 78a of the first planetary gearing 72a. The sun gear 28a of the second planetary gearing 22a is also realized as a first output of the second planetary gearing 22a, and realized to drive the impact mechanism 12a. The ring gear 46a of the second planetary gearing 22a is connected in a rotationally fixed manner to the housing element 82a of the machine housing 54a, i.e. is stationary. It is also conceivable in principle for the ring gear 46a of the second planetary gearing 22a to be directly connected in a rotationally fixed manner to the machine housing 54a. The planet carrier 48a of the second planetary gearing 22a is realized as a second output of the second planetary gearing 22a, and likewise provided to drive the impact mechanism 12a.

For the purpose of driving the impact mechanism 12a, the first output of the second planetary gearing 22a is coupled in a rotationally fixed manner to the cylinder 14a of the impact mechanism 12a. The sun gear 28a of the second planetary gearing 22a is connected in a rotationally fixed manner to the cylinder 14a of the impact mechanism 12a. It would also be conceivable in principle for the cylinder 14a of the impact mechanism 12a to constitute a single piece with the sun gear 28a of the cylinder 14a. The second output, i.e. the planet carrier 48a of the second planetary gearing 22a, is connected in a rotationally fixed manner to the piston 16a of the impact mechanism 12a. If the first output, i.e. the sun gear 28a, and the second output, i.e. the planet carrier 48a, have differing rotational speeds, a differential rotational speed ensues between the cylinder 14a and the piston 16a, as a result of which the cam mechanism 18a generates axial driving of the piston 16a inside the cylinder 14a. If the second planetary gearing 22a is in an unblocked state, the sun gear 28a, i.e. the first output, and the planet carrier 48a always have differing rotational speeds. The tool receiver 38a is likewise driven via the second output, i.e. the planet carrier 48a of the planetary gearing 22a. In this case, the second output, i.e. the planet carrier 48a of the planetary gearing 22a, drives the tool receiver 38a rotationally, causing a tool that is present in the tool receiver 38a to rotate. In this case, a coupling point, not represented in greater detail in FIG. 1, is integrated between the planet carrier 48a of the planetary gearing 22a and the tool receiver 38a, by means of which coupling point a rotationally fixed connection between the planet carrier 48a of the second planetary gearing 22a and the tool receiver 38a can optionally be made or undone. The coupling point can be used to switch on or switch off a drilling operating mode of the hand power tool 10a. For the purpose of deactivating an impact operating mode, in which the impact mechanism 12a impacts on the tool clamped in the tool receiver 38a, either in addition to a rotation or exclusively, the impact mechanism device has a further coupling point, not represented in greater detail in FIG. 1. The coupling point may be provided, for example, to block the second planetary gearing 22a. As a result of blocking of the second planetary gearing 22a, the sun gear 28a and the planet carrier 48a, i.e. the first output and the second output of the second planetary gearing 22a, rotate at the same rotational speed, such that there would be no relative rotational speed between the cylinder 14a and the piston 16a, as a result of which the axial movement of the piston 16a inside the cylinder 14a is prevented by the cam mechanism 18a.

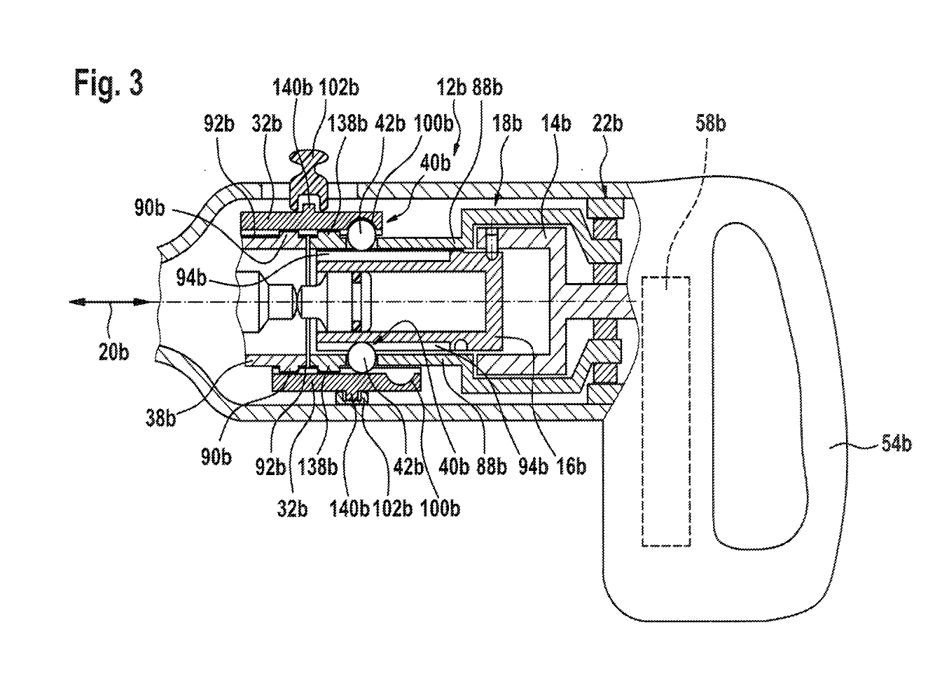

Further exemplary embodiments of the disclosure are shown in FIGS. 3 to 6. The descriptions that follow and the drawings are each limited substantially to the differences between the exemplary embodiments, and in principle reference may also be made to the drawings and/or to the description of the other exemplary embodiments, in particular of FIGS. 1 and 2, in respect of components having the same designation, in particular relating to components having the same references. To distinguish the exemplary embodiments, the letter a has been appended to the references of the exemplary embodiment in FIGS. 1 and 2. In the exemplary embodiments of FIGS. 3 to 6, the letter a has been replaced by the letters b, d, e.

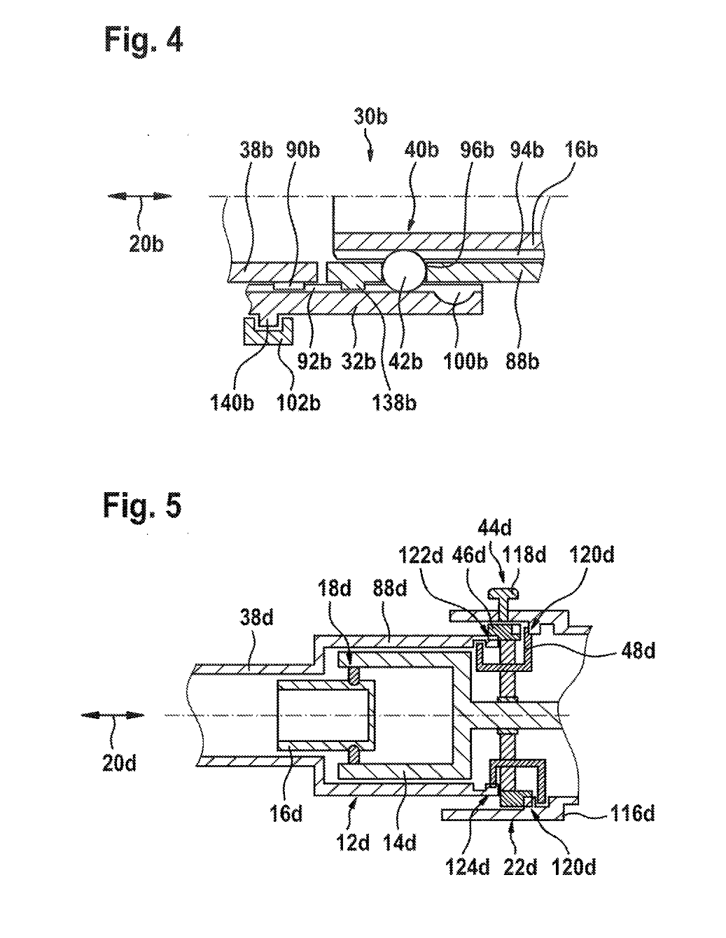

FIGS. 3 and 4 show a second exemplary embodiment of an impact mechanism device according to the disclosure. FIGS. 3 and 4 show a hand power tool 10b comprising the impact mechanism device according to the disclosure. Unlike the first exemplary embodiment, the hand power tool 10b, realized as a rotary hammer, has a differently designed machine housing 54b, in which the impact mechanism device according to the disclosure is disposed. The machine housing 54b is realized in an L-shaped design. In a manner similar to the first exemplary embodiment, the impact mechanism device likewise has a second planetary gearing 22b, a drive unit 58b, and an impact mechanism 12b comprising a piston 16b and a cylinder 14b. For the purpose of driving the piston 16b, the impact mechanism device in this case has a cam mechanism 18b, which drives the piston 16b via the cylinder 14b. The second planetary gearing 22b, and the cylinder 14b and the piston 16b, are realized in a manner that is substantially equivalent to the first exemplary embodiment.

The impact mechanism device comprises a switching device 30b for switching various operating modes of the hand power tool 10b. Three operating modes, namely chiseling, hammer drilling and drilling, can be switched by means of the switching device 30b. In this case, the switching device 30b is realized as a mechanical switching device 30b. The various operating modes can be adjusted in a purely mechanical manner by means of the switching device 30b. The switching device 30b comprises a slide sleeve 32b, which is disposed in a front region of the piston 16b, at a transition to a tool receiver 38b. In this case, the slide sleeve 32b is disposed radially outside of a driver element 88b, via which the piston 16b can be driven by a second output of the second planetary gearing 22b. The driver element 88b is realized as a hollow cylinder, which is disposed radially outside of the piston 16b. The driver element 88b is connected in a rotationally fixed manner to the second output of the second planetary gearing 22b. The slide sleeve 32b is axially displaceable in this case. For the purpose of switching the three operating modes, the slide sleeve 32b has three switching positions. Each of the three switching positions is represented in this case by an axial position of the slide sleeve 32b on the driver element 88b. The slide sleeve 32b is connected in a rotationally fixed manner to the river element 88b. The driver element 88b comprises form closure elements 138b, via which the slide sleeve 32b is connected in a form-closed manner to the driver element 88b. The slide sleeve 32b has form closure elements 92b, which are realized to correspond to the form closure elements 138b. For the purpose of connecting the slide sleeve 32b in a rotationally fixed manner, the form closure elements 138b of the driver element 88b and the form closure elements 92b of the slide sleeve 32b engage in each other in a form-closed manner. It is conceivable in this case for the form closure elements 92b, 138b to be realized as a toothing. As a result, the slide sleeve 32b can only be displaced axially on the driver element 88b, but not turned in relation to the latter. The slide sleeve 32b projects beyond the driver element 88b in the direction of the tool receiver 38b. On a side that faces toward the driver element 88b, the tool receiver 38b has a plurality of form closure elements 90b, which are provided for coupling to the slide sleeve 32b. The form closure elements 90b in this case are realized as protrusions disposed in a distributed manner on a circumference of the tool receiver 38b, which protrude radially outward. It is also conceivable in principle for the form closure elements 90b to be realized as teeth of a toothing disposed on the circumference of the tool receiver 38b. The form closure elements 92b of the slide sleeve 32 are likewise realized to correspond to the form closure elements 90b of the tool receiver 38b. If the tool receiver 38b and the slide sleeve 32b are connected to each other via their form closure elements 90b, 92b, the tool receiver 38b and the slide sleeve 32b are coupled to each other in a rotationally fixed manner. In this case, a rotation introduced into the slide sleeve 32b via the driver element is transmitted to the tool receiver 38b, and a tool clamped in the tool receiver 38b rotates. In the first switching position and in a second switching position, the form closure elements 92b of the slide sleeve 32b engage in the form closure elements 90b of the tool receiver. As a result, the tool receiver 38b is driven rotationally in the first and in the second switching position of the slide sleeve 32b. In the third switching position of the slide sleeve 32b, the form closure elements 92b of the slide sleeve 32b are separated from the form closure elements 90b of the tool receiver 38b, as a result of which a rotationally fixed coupling of the tool receiver 38b and the slide sleeve 32b is disconnected. In this case, the first switching position is realized as a position of the slide sleeve 32b shifted maximally in the direction of the tool receiver 38b. The second switching position is realized as a middle position of the slide sleeve 32b. Accordingly, the third switching position of the slide sleeve 32b is realized as position of the slide sleeve 32b that is maximally in the direction of the second planetary gearing 22b, i.e. maximally distant from the tool receiver 38b.

For the purpose of deactivating an impact operating mode of the impact mechanism 12b, the switching device 30b comprises a coupling point 40b. The coupling point 40b is provided for separably coupling the piston 16b and the river element 88b. For this purpose, the piston 16b has, on a region that faces toward the driver element 88b, a plurality of form closure elements 94b disposed on an offset outer circumference. The form closure elements 94b in this case are realized as protrusions, which extend radially outward from the outer circumference of the piston 16b. For the purpose of coupling to the form closure elements 94b of the piston 16b, the coupling point 40b has radially displaceable form closure elements 42b. The radially displaceable form closure elements 42b are realized as balls, which are each disposed in a radially extending through recess 96b in the driver element 88b. It is also conceivable in principle for the form closure elements 42b coupled to the driver element 88b to be realized, for example, as pins. The form closure elements 42b coupled to the driver element 88b each have two switching positions. In a first switching position, the form closure elements 42b project radially inward into the driver element 88b, and in this case they come into form-closed contact with the form closure elements 94b of the piston 16b and thus couple the piston 16b in a rotationally fixed manner to the driver element 88b. As a result, in a first switching position of the form closure elements 42b, the piston 16b rotates at a rotational speed of the driver element 88b, and a differential rotational speed between the piston 16b and the cylinder 14b causes the piston 16b to be moved axially back and forth in an impact motion, by means of the cam mechanism 18b. In this case, the form closure elements 42b, by a radially outer end, bear against a radial inside 98b of the slide sleeve 32b. As a result, the form closure elements 42b are held in a form closure in the first position by the slide sleeve 32b. In this case, in the second and third switching positions of the slide sleeve 32b, the form closure elements 42b are held by the slide sleeve 32b in the first switching position. As a result, an impact operating mode of the impact mechanism 12b is activated in the second and third switching positions of the slide sleeve 32b. For the purpose of deactivating the impact operating mode of the impact mechanism 12b, the slide sleeve 32b has a recess 100b each form closure element 42b coupled to the driver element 88b, the recesses 100b being disposed on the radial inside 98b of the slide sleeve 32b. The recesses 100b in this case are all made at the same axial position in the inside 98b of the slide sleeve 32b. In the first switching position of the slide sleeve 32b, the recesses 100b are congruent with the radially displaceable form closure elements 42b coupled to the driver element 88b. As a result, the form closure elements 42b coupled to the driver element 88b in the first switching position of the slide sleeve 32b slide radially outward into their second switching position, into the congruently disposed recesses 100b in the inside 98b of the slide sleeve 32b. In this case, the form closure elements 42b are driven radially outward into the recesses 100b by the centrifugal forces that occur upon a rotation of the driver element 88b. In the second switching position of the form closure elements 42b, in which they are disposed in the respective recesses 100b, the form closure elements 42b are separated from the form closure elements 94b of the piston 16b. A form-closed connection between the form closure elements 94b of the piston 16b and the form closure elements 42b coupled to the driver element 88b is undone in the second switching position of the form closure elements 42b, which go into the first switching position of the slide sleeve 32b, as a result of which a rotationally fixed coupling of the piston 16 to the driver element 88b is undone. The slide sleeve 32b, in its first switching position, releases the form closure elements 42b.

In the first switching position of the slide sleeve 32b, the tool receiver 38b is connected in a rotationally fixed manner to the slide sleeve 32 via the form closure elements 90b, 92b. The form closure elements 42b coupled to the driver element 88b are disposed in the respective recesses 100b of the slide sleeve 32b and separated from the form closure elements 94b of the piston 16b. The first switching position of the slide sleeve 32b thereby generates the operating mode of drilling, in which only the tool receiver 38b rotates, but no impact pulse is generated by the impact mechanism 12b. In the second switching position of the slide sleeve 32b, the tool receiver 38b is connected in a rotationally fixed manner to the slide sleeve 32 via the form closure elements 90b, 92b. The form closure elements 42b coupled to the driver element 88b are pressed radially inward, via the inside 98b of the slide sleeve 32b, and are in form-closed contact with the form closure elements 94b of the piston 16b, such that the piston 16b is coupled in a rotationally fixed manner to the driver element 88b. As a result, the second, middle switching position of the slide sleeve 32b generates the operating mode of hammer drilling, in which the tool receiver 38b rotates and an impact pulse is additionally generated by the impact mechanism 12b. In the third switching position of the slide sleeve 32, the tool receiver 38b is separated from the slide sleeve 32. The form closure elements 92b of the slide sleeve 32b are separated from the form closure elements 90b of the tool receiver 38b. In the third switching position of the slide sleeve 32, the form closure elements 42b coupled to the driver element 88b are pressed radially inward, via the inside 98b of the slide sleeve 32b, and are in form-closed contact with the form closure elements 94b of the piston 16, such that the piston 16 is coupled in a rotationally fixed manner to the driver element 88b. As a result, the third switching position of the slide sleeve 32b generates the operating mode of chiseling, in which the tool receiver 38b does not rotate, and only an impact pulse is generated by the impact mechanism 12b. The switching device 30b in this case comprises an actuating element 102b, by means of which an operator can manually switch the slide sleeve 32b into the various switching positions. The actuating element 102b is realized as a sleeve, which encompasses the slide sleeve 32b. In this case, a lever element of the actuating element 102b projects out of the machine housing 54b, from which it can be contacted and operated by an operator. The slide sleeve 32b comprises a driver element 140b, via which the slide sleeve 32b is coupled to the actuating element 102b. The driver element 140b is realized as a protrusion that extends on the outside of the slide sleeve 32b and that is in form-closed contact with the driver element for the purpose of coupling to the actuating element 102b. It is also conceivable in principle for the slide sleeve 32b to be displaced directly by an operator.

FIG. 5 shows a third exemplary embodiment of an impact mechanism device according to the disclosure. The impact mechanism device is realized in substantially the same manner as the impact mechanism device from the first exemplary embodiment from FIGS. 1 and 2. In this case, the impact mechanism device is represented merely schematically here. In a manner similar to the first exemplary embodiment, the impact mechanism device likewise has a second planetary gearing 22d, and an impact mechanism 12d comprising a piston 16d and a cylinder 14d. The second planetary gearing 22d, and the cylinder 14d and the piston 16d, are realized in a manner that is substantially equivalent to the first exemplary embodiment. In this case, for the purpose of driving the piston 16d, the impact mechanism device has a cam mechanism 18d, which drives the piston 16d via the cylinder 14d.

The impact mechanism device comprises a mechanical switchover unit 44d, by means of which the direction of rotation of a tool, disposed in a tool receiver 38d, can be reversed. The mechanical switchover unit 44d in this case for switching over the direction of rotation is provided to fix optionally a ring gear 46d or a planet carrier 48d of the second planetary gearing 22d. The mechanical switchover unit 44d comprises a switching sleeve 116d, which is displaceable in an axial direction 20d. Mounted on the switching sleeve 116d in this case is an actuating element 118d, by means of which an operator can displace the switching sleeve 116d in the axial direction 20d. The second planetary gearing 22d is mounted inside the switching sleeve 116d. The switching sleeve 116d comprises a form closure element 120d, via which the switching sleeve 116d can be coupled in a rotationally fixed manner to the ring gear 46d or to the planet carrier 48d of the second planetary gearing 22d. The switching sleeve 116d comprises a first switching position and a second switching position. To illustrate the two differing switching positions, FIG. 5 shows an upper half of the impact mechanism device with the switching sleeve 116d in the first switching position and a lower half of the impact mechanism device with the switching sleeve 116d in the second switching position. In the first switching position of the switching sleeve 116d, the planet carrier 48d is connected in a rotationally fixed manner to the switching sleeve 116d, via the form closure element 120d, and is thereby fixed. The ring gear 46d of the second planetary gearing 22d can rotate and, via a coupling point 122d, is connected in a rotationally fixed manner to a driver element 88d of the impact mechanism device that is provided for rotationally driving the tool receiver 38d and the piston 16d of the impact mechanism 12d. This results in driving of the driver element 88d, i.e. the tool receiver 38d and the piston 16d, via the ring gear 46d of the second planetary gearing 22d that, in this switching position, is realized as an output of the second planetary gearing 22d. For the purpose of switching over into the second switching position, the switching sleeve 116d is displaced in the axial direction 20d, in the direction of the tool receiver 38d. In the second switching position, the form closure element 120d is coupled to the ring gear 46d of the second planetary gearing 22d, and thus fixes the latter. The planet carrier 48d of the second planetary gearing 22d can rotate and, via a coupling point 124d, is connected in a rotationally fixed manner to the driver element 88d of the impact mechanism device. This results in driving of the driver element 88d, i.e. the tool receiver 38d and the piston 16d, via the planet carrier 48d of the second planetary gearing 22d that, in this switching position, is realized as an output of the second planetary gearing 22d. The switchover of the output of the second planetary gearing 22d, which in the first switching position is constituted by the ring gear 46d and in the second switching position is constituted by the planet carrier 48d, the planet carrier 48d being fixed in the first switching position and the ring gear 46d being fixed in the second switching position, causes a direction of rotation of the driver element 88d to be reversed, respectively, in both switching positions. As a result, an operator can easily effect mechanical switchover of a direction of rotation of a tool in the tool receiver 38d.

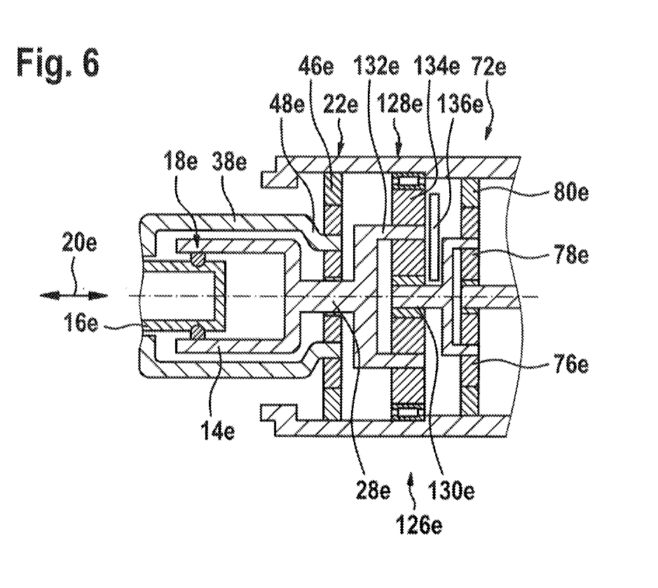

FIG. 6 shows a fourth exemplary embodiment of a impact mechanism device according to the disclosure. The impact mechanism device is realized in substantially the same manner as the impact mechanism device from the first exemplary embodiment from FIGS. 1 and 2. In this case, the impact mechanism device is represented merely schematically here. In a manner similar to the first exemplary embodiment, the impact mechanism device likewise has an impact mechanism 12e comprising a piston 16e and a cylinder 14e. The second planetary gearing 22e, and the cylinder 14e and the piston 16e, are realized in a manner that is substantially equivalent to the first exemplary embodiment. In this case, for the purpose of driving the piston 16e, the impact mechanism device has a cam mechanism 18e, which drives the piston 16e via the cylinder 14e. The impact mechanism device comprises a gearing device 126e, by means of which two gears can be switched. In the differing gear, the gearing device 126e has respectively differing gear ratios. For the purpose of realizing the gearing device 126e, the impact mechanism device, as in the first exemplary embodiment from FIGS. 1 and 2, has a first planetary gearing 72e and the second planetary gearing 22e. The gearing device 126e has a third planetary gearing 128e, which is disposed between the first planetary gearing 72e and the second planetary gearing 22e. A planet carrier 78e of the first planetary gearing 72e is coupled to a sun gear 130e of the third planetary gearing 128e. A planet carrier 132e of the third planetary gearing 128e is coupled in a rotationally fixed manner to a sun gear 28e of the second planetary gearing 22e. A ring gear 134e of the third planetary gearing 128e is rotatably mounted. The gearing device 126e comprises a switching element 136e, which is provided for blocking the third planetary gearing 128e. The switching element 136e in this case is shown only schematically in FIG. 6. In the first switching position of the switching element 136e, the third planetary gearing 128e is unblocked. In the second switching position of the switching element 136e, the third planetary gearing 128e is blocked. For the purpose of blocking the third planetary gearing 128e, the switching element 136e connects the ring gear 134e of the third planetary gearing 128e in a rotationally fixed manner to the sun gear 130e of the third planetary gearing 128e. As a result, the third planetary gearing 128e is blocked and, as it were, bridged. A rotational speed is no longer converted in the third planetary gearing 128e. For the same input rotational speed, via the sun gear 130e, the planet carrier 132e, in a first switching position of the switching element 136e, has a different rotational speed than in the second switching position of the switching element 136e.

It is also conceivable in principle for the gearing device 126e to be designed in a different manner, considered appropriate by persons skilled in the art, for switching various gear speeds in the hand power tool 10e. It is thus conceivable, for example, for only two planetary gearings 22e, 72e to be provided for switching various gear speeds, and for switching of the various gear speeds to be effected by releasing and holding either the ring gear or the planet carrier of the corresponding planetary gearing 22e, 72e.

It is also to be noted here, in principle, that the differing exemplary embodiments may also be combined in a common hand power tool 10. It is thus conceivable, for example, for switching of the operating modes from the second exemplary embodiment to be combined with the gearing device from the fifth exemplary embodiment. Further combinations are likewise conceivable.

What is claimed is:

1. An impact mechanism device for a hand power tool, comprising:
at least one impact mechanism including at least one driven cylinder and at least one piston, the at least one piston driven in an axial direction by the at least one driven cylinder via a cam mechanism; and
at least one planetary gearing configured to drive the at least one driven cylinder and the at least one piston,
wherein the at least one piston is positioned at least partially inside the at least one driven cylinder.

2. The impact mechanism device according to claim 1, wherein the at least one piston is at least one hollow piston configured to move axially to generate a pressure impulse.

3. The impact mechanism device according to claim 1, wherein:
a first outer curve is defined on an outer circumference of the at least one piston; and
the first outer curve defines the cam mechanism.

4. The impact mechanism device according to claim 3, wherein:
a second outer curve is defined on the outer circumference of the at least one piston; and
the first outer curve together with the second outer curve define the cam mechanism.

5. The impact mechanism device according to claim 4, wherein the first outer curve and the second outer curve are distributed in a non-uniform manner on the outer circumference of the at least one piston.

6. The impact mechanism device according to claim 3, wherein:
the at least one piston is formed from a first, lighter material; and
the first outer curve and the second outer curve are formed from a second, harder material.

7. The impact mechanism device according to claim 1, wherein the at least one driven cylinder includes at least one form closure element configured to engage in the first outer curve and the second outer curve to guide the at least one piston.

8. The impact mechanism device according to claim 1, wherein:
the at least one planetary gearing includes a first output and a second output;
the at least one driven cylinder is driven by the first output; and
the at least one piston is driven by the second output.

9. The impact mechanism device according to claim 8, wherein the first output is a sun gear of the at least one planetary gearing.

10. The impact mechanism device according to claim 1, further comprising at least one switching device configured to mechanically switch between various operating modes.

11. The impact mechanism device according to claim 10, wherein:
the at least one switching device includes at least one slide sleeve having form closure elements; and
the closure elements are configured to couple to a tool receiver, and further configured to actuate a coupling point of the switching device to couple the at least one piston.

12. The impact mechanism device according to claim 11, wherein the coupling point comprises radially displaceable form closure elements configured to be held in a form closure or released by the at least one slide sleeve to couple or decouple the at least one piston.

13. The impact mechanism device according to claim 1, further comprising:
a mechanical switchover unit; and
a tool receiver,
wherein the at least one planetary gearing includes a first planetary gearing and a second planetary gearing; and
wherein the mechanical switchover unit is configured to switch over a direction of rotation of the tool receiver to optionally fix a ring gear or a planet carrier of the second planetary gearing.

14. A hand power tool comprising:
an impact mechanism device, including:
at least one impact mechanism having at least one driven cylinder and at least one piston, the at least one piston driven in an axial direction by the at least one driven cylinder via a cam mechanism; and
at least one planetary gearing configured to drive the at least one driven cylinder and the at least one piston,
wherein the at least one piston is positioned at least partially inside the at least one driven cylinder.
